(19) United States
(12) Patent Application Publication
(10) Pub. No.: US 2008/0170032 A1
(43) Pub. Date: Jul. 17, 2008

(54) DEVICE AND SYSTEM FOR PRESENTING INFORMATION

(75) Inventor: Jeffrey Raynor, Edinburgh (GB)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics (Research & Development) Limited, Marlow (GB)

(21) Appl. No.: 11/680,135

(22) Filed: Feb. 28, 2007

(30) Foreign Application Priority Data
Mar. 1, 2006 (EP) 06004120.9

(51) Int. Cl. G09G 5/00

(52) U.S. Cl. 345/156

(57) ABSTRACT

A presentation system includes a display for displaying data, and an input device for generating a distinctive mark on the display. The distinctive mark has pulse width modulation characteristics. A processor carries out an action determined by the distinctive mark. An image capture device remote from the display detects the distinctive mark on the display. The image capture device is coupled to the processor, and includes a detector. The detector detects the distinctive mark on the display, determines location of the distinctive mark relative to the display, and determines the pulse width modulation characteristics of the distinctive mark corresponding to the action to be carried out by the processor.

### FIELD OF THE INVENTION

The present invention is directed to remotely controlling a computer, and more particularly, to a device that detects specific information and allows a computer to interpret this information.

### BACKGROUND OF THE INVENTION

It is well known for a user to use a video presentation system to present to an audience an electronic document stored on a computer. This type of presentation system generally comprises a projector linked to a computer or laptop. Generally, the computer or projector is in one location and the projector screen is in a different location.

The user will use a peripheral to assist in presenting the document on the projector screen. The peripheral allows the user to initiate certain actions on the document being projected. For example, the user can enter the menu of the application managing the document and select an available function to go to the next slide of the document or to click on a link displayed in the document to close the document, or other kinds of similar functions.

There are many known peripherals used to make selections and point out information in such an environment as described above. These include a conventional mouse, a wireless mouse, a gyroscopic mouse and a pointer. Each of these peripherals fail to provide an ideal approach to the problems encountered when a user makes a presentation in a large venue, and where the data being presented on a projector screen is stored remotely, e.g., on a computer.

U.S. published patent application no. 2003/0222849 to Starkweather discloses a system for remote electronic projection using a frequency shift keying (FSK) modulation technique. The frequency of the modulation is used to determine the action required by the user. The frequency is higher than the human visual system and can be changed. However, this would require changes to the camera to be able to detect the modulation frequency and the increased frequency of pressing the button. The camera frame rate needs to be significantly higher (Nyquist sampling) than the modulation frequency.

This has a number of disadvantages. Namely, the increased camera frame rate required is hard to achieve when it is already at a maximum or near maximum. Also, an increased bandwidth between the camera and the processing system is needed. In addition, more data processing is required, and camera sensitivity is reduced due to a lower amount of time for collecting the light.

### SUMMARY OF THE INVENTION

In view of the foregoing background, an object of the present invention is to overcome the above-identified problems.

According to one aspect of the present invention, an image capture device detects a distinctive mark or cursor generated by an input device on a display medium remote from the image capture device. The input device may input at least one pulse width modulation characteristic on the distinctive mark since the image capturing device is connected to a processor that carries out an action determined by the distinctive mark. The image capture device may further comprise a detector for detecting the distinctive mark on the display medium. The detector may also determine the exact location of the distinctive mark relative to the display medium, and determine the pulse width modulation characteristics for determining the action required to be made by the processor.

The image capturing device may advantageously detect a mark sent by an input device on the distant screen, and provide the computer with relevant location information to generate an action related to both the location information and the action requested by the user.

### BRIEF DESCRIPTION OF THE DRAWINGS

Reference will now be made by way of example to the accompanying drawings, in which:

FIG. 1 is an overview of the system according to the present invention;

FIG. 2 is an input device for use with the system according to the present invention; and

FIGS. 3, 4 and 5 are graphs of time versus laser output for different modulations according to the present invention.

### DETAILED DESCRIPTION OF THE PREFERRED EMBODIMENTS

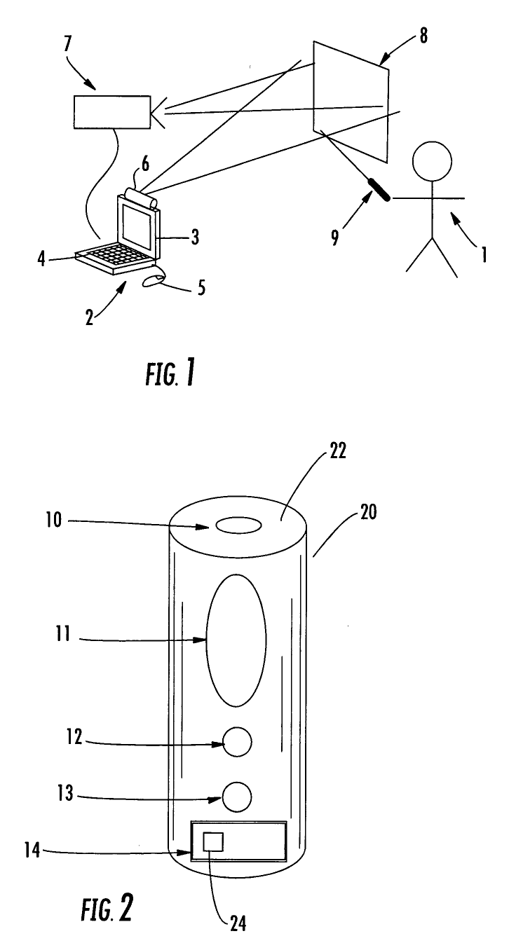

FIG. 1 discloses a user operating a presentation system remotely presenting data, such as an electronic document. The presentation system comprises a number of different devices, including a computer 2. The computer can be a personal computer, a laptop or any other suitable device, such as a personal digital assistant (PDA). For purposes of illustrating the present invention, a computer is used as the suitable device.

The computer is able to operate with a number of different applications such as Word, Excel, PowerPoint, a web browser such as Firefox or Mozilla, a drawing package such as Corel Draw, AutoCAD, a media player such as Win Amp or other office package such as Open Office, etc. The computer also has means or a memory for storing documents and data for the application. In addition, the computer can manage other types of applications such as drivers for the peripherals.

The computer may also include other elements such as a screen 3, a keyboard 4, and a mouse 5. When the mouse 5 or the keyboard 4 is used, a cursor is visible on the computer screen 3 in the document displayed thereon. The computer may also comprise a web cam 6 or other appropriate image capture device that can be part of the computer, or externally connected to the computer. The web cam or computer may comprise software for dealing with images. The web cam may be located near or on the computer to view and record in any direction. Thus, the web cam can view a user in front of the screen, or anything around the computer.

The computer is also connected to a video projector system 7 that allows the computer to project images from the computer screen to a projector screen 8. Thus, the images can be remotely seen on the screen. The screen may not actually exist as the function may be provided by a wall or other surface.

User 1 stands between the computer and the distant projector screen but is generally is closer to the screen 8 so that the user can give the presentation. The user comments on the presentation displayed on the screen, and uses an input device 9 to indicate specific locations on the screen 8. The user can also use the input device 9 to operate the computer 2, as we be will described in greater detail below.

Referring now to FIG. 2, the input device is shown in greater detail. The input device has a cylindrical body 20 having a length of approximately 10 to 20 centimeters. Alternatively, another similar form that fits comfortably in the user's hand may also be used. An aperture 10 is made on the circular surface 22. This aperture provides the output for a signal, such as a laser beam or another type output signal, for example.

The output signal has several distinctive characteristics, for example, a specific type modulation, frequency or form. The output can be pointed at the screen 8 and is visible thereon. The input device includes other inputs and other outputs, which may be the illustrated buttons 11, 12 and 13, for example. Each button is for a different function. The first button 11 has an elliptic form. It is advantageous for the first button 11 to have a form readily identifiable from the other buttons. The first button has a function similar to that of a laser pointer, i.e., it provides a beam to illuminate part of the screen. The first button also allows the user to launch a mouse mode that sets the input device as a pointer.

The second button 12 and the third button 13 have the same roles as the left and right buttons of a conventional mouse. These buttons can launch an action by clicking on any icon or any entry in a menu of the application being used. The third button can launch the contextual menu that includes sub-entries of menu entries, for example, cut or paste functions. Other functions are available depending the type of application used. At the end of the cylindrical form a fourth button 14 is located and includes a slider 24 on the surface which can slide from left to right to switch on or off the input device. The fourth button 14 is optional.

The following represents how the system operates. A user is remotely presenting a presentation that is displayed on the distant projector screen 8. The user clicks on the mouse mode button 11 of the input device, and a laser beam is output through the aperture 10 of the input device. The laser beam may correspond with a point that is displayed on the image on the projector screen.

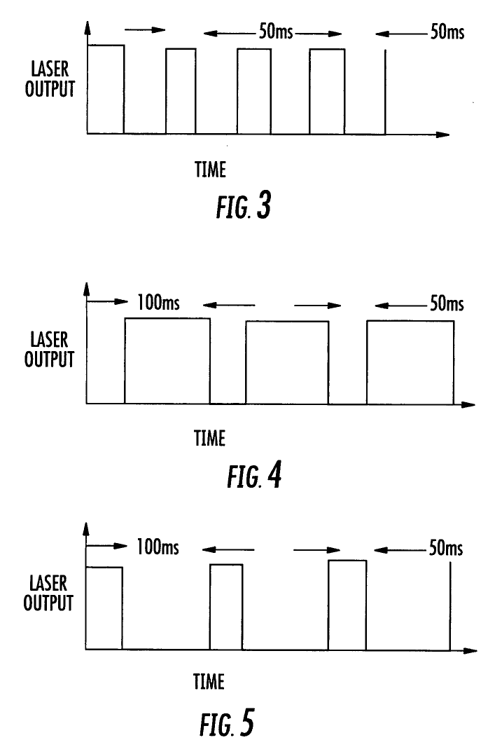

The location of the point depends on the orientation of the input device. The laser beam is temporarily modulated as shown in FIG. 3. The frequency of modulation is on the order of 10 Hz to 100 Hz. Thus, the web cam can distinguish this point on the screen from any other point belonging in the presentation. In the frequency range of 10 Hz to 100 Hz, the web cam can detect the intermittency of the signal but any person looking at the presentation cannot identify that the laser beam is pulsating.

Accordingly, the web cam detects the modulated laser signal on the distant projector screen, and can determine the location information for the point on the distant screen. For example, the location information is either transmitted to software integrated in the web cam or in the computer. Appropriate calculations are made to determine the exact location of the pointer relative to the presentation.

The computer can then associate the cursor on the computer screen with the signal on the distant screen produced by the input device. Thus, the cursor of the computer is displayed on the distant screen. The user can then click on the left or right buttons of the input device to cause an action based on the location of the cursor to ensure that the web cam or the computer detect the laser beam produced by pressing the left hand or right hand buttons. Each signal is modulated with a specific pulse width modulation technique.

If the click is a left hand click, the laser beam is modulated as shown in FIG. 4, for example. If the click is a right hand click, the laser beam is modulated as shown in FIG. 5, for example. The mark space for each button on the input device is chose to be distinct. This is one way of distinguishing each action.

However, there are many other ways of doing this. For example, a specific pulse-train (e.g., pulse-code modulation) can be emitted by the laser-pointer to identify each button, or the pointer could have a secondary illumination source, preferably of a different color or wavelength). This would be enabled to indicate a button press. Alternatively, the brightness of the laser pointer could be modulated to indicate a button press. The advantage of a pulse-width modulation scheme is that it is simple, and therefore, inexpensive to implement in both the laser pointer and also to detect.

The distance between the user and the distant screen is not a known value and may vary from one moment to the next. Each user can be located at any distance from the distant screen. Similarly, the size of the distant screen is not always known in advance.

Accordingly, a calibration step may be required prior to use. The calibration may adapt the laser output of the input device to the distant screen or the image captured by the web cam. To realize this calibration, the software integrated in the web cam or in the computer requires a beam to be transmitted to, for example, three corners of the distant screen. This will enable vertical and horizontal scaling factors to be determined and used thereafter. In the examples of modulation where mark space ration is not used, the calibration technique may be different.

As the laptop screen and projection screen are not aligned along the same principal axis of the screen, there will be some spatial compression of the image and the vertical scaling factor will not necessarily be the same as the horizontal scaling factor.

It is common for a user to move around during the presentation. If the person moves closer to or further away, this will have only a minimal effect on the laser spot brightness. The laser is a coherent light source with little beam divergence, and small changes in intensity with distance. Even with a small change in brightness, the on-off periods of the pulsing pointers will be readily identifiable. However, the mark-space ratio is independent.

It will be appreciated that the examples presented herein are not the only ways of carrying out the invention, and variations will be evident to those skilled in the art.

1-15. (canceled)

16. An image capture device for detecting a distinctive mark generated by an input device on a display spaced from the image capture device, the input device causing the distinctive mark to have at least one pulse width modulation characteristic, the image capture device coupled to a processor that carries out an action determined by the distinctive mark, and comprising:
a detector for performing the following
detecting the distinctive mark on the display,
determining a location of the distinctive mark relative to the display, and
determining the at least one pulse width modulation characteristic of the distinctive mark corresponding to the action to be carried out by the processor.

17. The image capture device of claim 16, further comprising a processor for causing data to be displayed on the display; and wherein said detector determines the location of the distinctive mark relative to the data.

18. The image capture device of claim 16, further comprising a calibrator for determining a size of the display, and a distance of the display from the input device.

19. The image capture device of claim 16, wherein the distinctive mark generated by the input device comprises an electromagnetic signal; and wherein said detector comprises an electromagnetic signal detector.

20. The image capture device of claim 16, wherein the distinctive mark generated by the input device comprises a laser signal; and wherein said detector comprises a laser signal detector.

21. The image capture device of claim 16, wherein said detector comprises a video camera.

22. An input device for generating a distinctive mark on a display spaced from an image capture device, the image capture device coupled to a processor that carries out an action determined by the distinctive mark, the input device comprising:
a housing; and
a pulse width modulator carried by said housing for generating the distinctive mark with at least one pulse width modulation characteristic.

23. The input device of claim 22, further comprising a plurality of actuation elements each producing a different pulse width modulation characteristic.

24. The input device of claim 22, wherein the distinctive mark is generated as an electromagnetic signal.

25. The input device of claim 24, wherein the electromagnetic signal is a laser signal.

26. A presentation system comprising:
a display;
an input device for generating a distinctive mark on said display, the distinctive mark having at least one pulse width modulation characteristic;
a processor that carries out an action determined by the distinctive mark; and
an image capture device spaced from said display for detecting the distinctive mark on said display, said image capture device cooperating with said processor for performing the following
detecting the distinctive mark on said display,
determining location of the distinctive mark relative to said display, and
determining the at least one pulse width modulation characteristic of the distinctive mark corresponding to the action to be carried out by said processor.

27. The presentation system of claim 26, wherein said processor also causes data to be displayed on said display; and wherein said image capture device and said processor further cooperate to determine the location of the distinctive mark relative to the data.

28. The presentation system of claim 26, wherein said image capture device comprises a calibrator for determining a size of said display, and a distance of said display from said input device.

29. The presentation system of claim 26, wherein the distinctive mark generated by said input device comprises an electromagnetic signal; and wherein said image capture device comprises an electromagnetic signal detector.

30. The presentation system of claim 26, wherein the distinctive mark generated by said input device comprises a laser signal; and wherein said image capture device comprises a laser signal detector.

31. The presentation system of claim 26, wherein said image capture device comprises a video camera.

32. The presentation system of claim 26, wherein said input device comprising a housing, and a pulse width modulator carried by said housing for generating the distinctive mark with the pulse width modulation characteristics.

33. The presentation system of claim 26, wherein said input device comprises a plurality of actuation elements each producing a different pulse width modulation characteristic.

34. The presentation system of claim 26, further comprising a projector for projecting data on said display.

35. A method for detecting a distinctive mark generated by an input device on a display remote from the image capture device, the method comprising:
operating the input device for generating the distinctive mark on the display, the distinctive mark having at least one pulse width modulation characteristic; and
operating the image capture device coupled to a processor that carries out an action determined by the distinctive mark, the image capture device cooperating with the processor for performing the following
detecting the distinctive mark on the display,
determining location of the distinctive mark relative to the display, and
determining the at least one pulse width modulation characteristic of the distinctive mark corresponding to the action to be carried out by the processor.

36. The method of claim 35, further causing data to be displayed on the display; and wherein the image capture device determines the location of the distinctive mark relative to the data.

37. The method of claim 35, wherein the image capture device comprises a calibrator for determining a size of the display, and a distance of the display from the input device.

38. The method of claim 35, wherein the distinctive mark generated by the input device comprises an electromagnetic signal; and wherein the image capture device comprises an electromagnetic signal detector.

39. The method of claim 35, wherein the distinctive mark generated by the input device comprises a laser signal; and wherein the image capture device comprises a laser signal detector.

40. The method of claim 35, wherein the image capture device comprises a video camera.
